(19) United States
(12) Patent Application Publication
(10) Pub. No.: US 2024/0077253 A1
(43) Pub. Date: Mar. 7, 2024

(54) DRYER FOR ELECTRODE MANUFACTURING

(71) Applicant: Rivian IP Holdings, LLC, Plymouth, MI (US)

(72) Inventors: Meng WANG, Pleasanton, CA (US); Debaditya BISWAS, Austin, TX (US); Ki Tae PARK, Santa Clara, CA (US); Edgar KOSGEY, Oakland, CA (US)

(21) Appl. No.: 17/902,603

(22) Filed: Sep. 2, 2022

(51) Int. Cl. F26B 13/08; B05C 5/02; F26B 3/347; H01M 4/04

(52) U.S. Cl. CPC F26B 13/08; B05C 5/0254; F26B 3/347; H01M 4/0404

(57) ABSTRACT

Described are embodiments of an electrode manufacturing system that pertains to batteries and methods of preparing batteries. In some embodiments, the system includes at least one coater configured to coat a side of an electrode substrate with an electrode slurry to form a coated electrode substrate. The system can also include a multi-pass dryer configured to dry the coated electrode substrate, wherein the web path length of the coated electrode substrate in the dryer is greater than a footprint length of the dryer.

### INTRODUCTION

This disclosure relates generally to batteries and methods of preparing batteries, and more specifically, to electrode manufacturing systems that include a dryer and methods of using such systems to prepare batteries.

### BRIEF SUMMARY

Current electrode manufacturing at scale is highly expensive and energy intensive. The most expensive and energy intensive steps of the electrode manufacturing process is the electrode coating and drying process. Specifically, most of these costs are captured in the energy required to operate the dryer/oven as well as the dryer footprint needed to dry at the required rate of evaporation and production throughput. In addition, current electrode coating and drying relies heavily on solvent usage (e.g., N-methylpyrrolidone (“NMP”), water). During the drying process, the solvent is removed via evaporation. Some of these solvents can be toxic. Thus, the evaporated exhaust gases containing these solvents should be captured, abated, and/or recovered which also significantly increases capital investment, factory footprint, and operational costs.

Reducing the equipment cost, footprint, and operational energy required for electrode manufacturing can make battery cells more available at lower prices. This can enable a faster expansion of clean energy solutions in multiple industries. Disclosed herein are systems and methods of manufacturing electrodes that utilize a multi-pass dryer in order to improve the battery manufacturing process.

In some embodiments, a system includes a coater configured to coat a side of an electrode substrate with an electrode slurry to form a coated electrode substrate; and a multi-pass dryer configured to dry the coated electrode substrate, wherein a web path length of the coated electrode substrate in the dryer is greater than a footprint length of the dryer. In some embodiments, the system includes a second coater configured to coat a second side of the electrode substrate opposite the first coated side of the electrode substrate with the electrode slurry to form a dual-side coated electrode substrate. In some embodiments, the multi-pass dryer is configured to dry the dual-side coated electrode substrate and a web path of the dual-side coated electrode substrate in the dryer changes direction multiple times before exiting the dryer. In some embodiments, the web path of the coated electrode substrate within the dryer changes direction multiple times before exiting the dryer. In some embodiments, a ratio of the web path length of the coated electrode substrate in the dryer to the footprint length of the dryer is 2:1 to 6:1. In some embodiments, the electrode slurry comprises at least 50% solids by mass. In some embodiments, the coater is a heated slot-die coater. In some embodiments, the web path of the coated electrode substrate is vertically stacked within the dryer. In some embodiments, the dryer comprises a plurality of rollers to move the coated electrode substrates along the web path. In some embodiments, the dryer comprises at least one inductive heating source configured to heat the web path of the coated electrode substrate. In some embodiments, the at least one inductive heating source comprises an induction coil wrapped around at least a portion of the web path of the coated electrode substrate. In some embodiments, the dryer comprises at least one infrared heat source configured to heat the web path of the coated electrode substrate. In some embodiments, the at least one infrared heat source comprises an infrared heating tube. In some embodiments, the dryer comprises at least one convective heating nozzle configured to direct a flow of heated air toward the web path of the coated electrode substrate. In some embodiments, the dryer comprises at least one floatation heating nozzle configured to float at least a portion of the web path of the coated electrode substrate with heated air.

In some embodiments, a multi-pass dryer includes an inlet configured to receive a coated electrode substrate; a plurality of rollers configured to move the coated electrode substrate along a web path that changes direction multiple times within the dryer; and an outlet configured to discharge the coated electrode substrate, wherein the dryer is configured to dry the coated electrode substrate. In some embodiments, the dryer includes a second inlet configured to receive a dual-side coated electrode substrate; a second plurality of rollers configured to move the dual-side coated substrate along a web path that changes direction multiple times within the dryer; and a second outlet configured to discharge the dual-side coated electrode substrate, wherein the dryer is configured to dry the dual-side coated electrode substrate.

In some embodiments, a method includes coating a first side of an electrode substrate with an electrode slurry; and drying the coated electrode substrate in a multi-pass dryer, wherein drying comprises moving the coated electrode substrate along a web path that changes direction multiple times within the dryer before exiting the dryer. In some embodiments, the method includes coating a second side of the electrode substrate opposite the first coated side of the electrode substrate with the electrode slurry to form a dual-side coated electrode substrate. In some embodiments, the method includes drying the dual-side coated electrode substrate comprising moving the dual-side coated electrode substrate along a web path that changes direction multiple times within the dryer before exiting the dryer.

The embodiments disclosed above are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a system, method, a device or apparatus, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example of a typical electrode coating and drying process;

FIG. 2 illustrates an example of an electrode manufacturing system in accordance with some embodiments disclosed herein;

FIG. 3 illustrates an example chart of electrode slurry solids content vs. viscosity in accordance with some embodiments disclosed herein;

FIG. 4 illustrates an example of inductive heating used to dry a coated electrode substrate in accordance with some embodiments disclosed herein;

FIG. 5 illustrates an example cross section of a top-down view of dryer location 216 indicated in FIG. 2 in accordance with some embodiments disclosed herein;

FIG. 6 illustrates example floatation heating nozzles used to dry a coated electrode substrate in accordance with some embodiments disclosed herein;

FIG. 7 illustrates example heating and cooling zones of a multi-pass dryer in accordance with some embodiments disclosed herein;

FIG. 8 illustrates a flow chart for a typical battery cell manufacturing process in accordance with some embodiments disclosed herein;

FIG. 9 depicts an illustrative example of a cross sectional view of a cylindrical battery cell in accordance with some embodiments disclosed herein;

FIG. 10 depicts an illustrative example of a cross sectional view of a prismatic battery cell in accordance with some embodiments disclosed herein;

FIG. 11 depicts an illustrative example of a cross section view of a pouch battery cell in accordance with some embodiments disclosed herein;

FIG. 12 illustrates cylindrical battery cells being inserted into a frame to form a battery module and pack in accordance with some embodiments disclosed herein;

FIG. 13 illustrates prismatic battery cells being inserted into a frame to form a battery module and pack in accordance with some embodiments disclosed herein;

FIG. 14 illustrates pouch battery cells being inserted into a frame to form a battery module and pack in accordance with some embodiments disclosed herein; and

FIG. 15 illustrates an example of a cross sectional view of an electric vehicle that includes at least one battery pack in accordance with some embodiments disclosed herein.

In the Figures, like reference numerals refer to like components unless otherwise stated herein.

### DETAILED DESCRIPTION

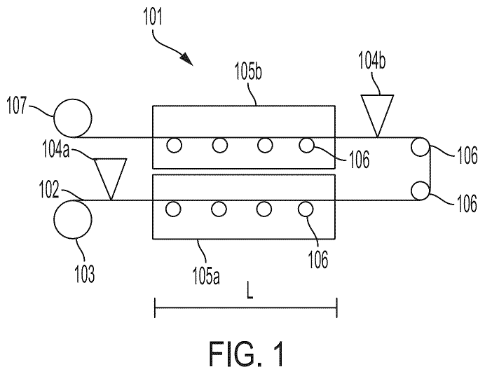

Disclosed herein are systems and methods of manufacturing electrodes that can reduce equipment cost, footprint, and operational costs (and energy) to improve the battery manufacturing process. A typical electrode slurry used to coat an electrode substrate can have high solvent content. For example, the solvent content can be 50% by mass of the electrode slurry. FIG. 1 illustrates an example of a typical electrode coating and drying process 101. In the typical process, a roll of an electrode substrate 102 is unwound (via unwinder 103) and a side of the electrode substrate is coated with an electrode slurry via electrode coater 104a to form a coated electrode substrate. The electrode substrate or coated electrode substrate is moved throughout the drying and coated process along a web path by web rollers 106. The coated electrode substrate then enters single pass dryer or oven 105a where the coated electrode substrate is dried. After passing through the single pass oven, the other side of the electrode substrate is coated with an electrode slurry via electrode coater 104b to form a dual-side coated electrode substrate. The dual-side coated electrode substrate then enters single pass dryer or oven 105b where the dual-side coated electrode substrate is dried. After the dual-side coated electrode substrate is dried, the electrode (i.e., the dried dual-side coated electrode substrate) is rewound into a roll (via rewinder 107).

During the drying process, the solvent is evaporated. Because the electrode slurry typically has such a high solvent content, the length L of the single pass oven can be tens of meters in length (e.g., 40 meters). Such an oven takes up an enormous factory footprint. In addition, because the solvents used to make these slurries often include toxic solvents such as N-methylpyrrolidone (“NMP”), the evaporation of these toxic solvents require large abatement systems to safely remove, recover, and/or dispose of these from the environment. These abatement systems also contribute to the factory's footprint.

One of the main causes of the cost, factory footprint, and energy requirement of the coating/drying electrode manufacturing process is the dryer sizing which can be driven by the solvent content. Accordingly, the electrode manufacturing systems and methods disclosed herein can reduce the solvent content in the electrode slurry (i.e., creating a high solids electrode slurry) and/or aggressively dry the electrode slurry on the electrode substrate by utilizing multiple passes within the same oven/dryer footprint.

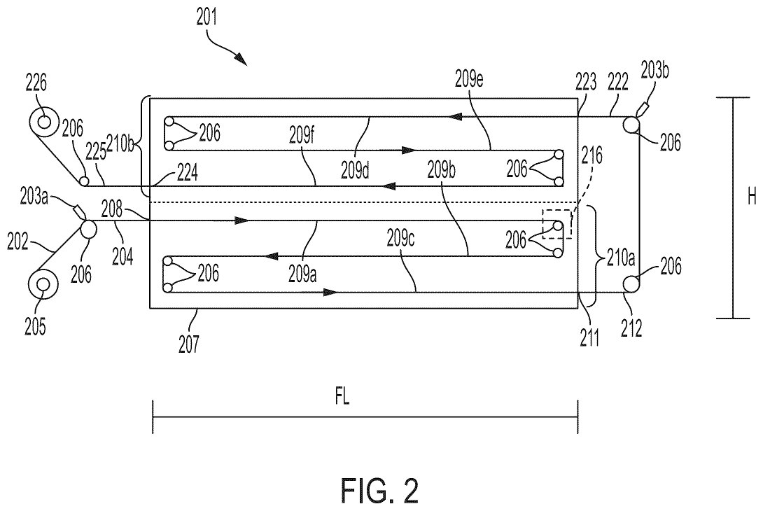

FIG. 2 illustrates an example of an electrode manufacturing system 201. In some embodiments, the electrode manufacturing system can include coating at least one side of an electrode substrate 202 with an electrode slurry. In some embodiments, the electrode manufacturing system can include a coater 203a configured to coat at least one side of the electrode substrate with the electrode slurry to form a coated electrode substrate 204. In some embodiments, the coater can be configured to coat both sides of the electrode substrate.

In some embodiments, the electrode substrate can be a current collector. In some embodiments, the current collector can be a ribbon or foil. In some embodiments, the current collector can include a metal or metal alloy. In some embodiments, the metal can be aluminum, copper, nickel, iron, titanium, stainless steel, or combinations thereof. In some embodiments, the current collector can include a carbonaceous material. In some embodiments, the current collector can be coated with carbon. For example, the current collector may be a metal that is coated with carbon (e.g., carbon-coated aluminum foil).

In some embodiments, a roll of the electrode substrate can be unwound (via unwinder 205) prior to being coated with the electrode slurry. In some embodiments, the electrode substrate can be moved throughout the electrode manufacturing system at least along web rollers 206.

In some embodiments, the electrode slurry can be deposited on at least one side of the electrode substrate via slot-die coating, gravure coating, electrostatic spray deposition, dry roll-to-roll electrode fabrication, or combinations thereof. In some embodiments, the coater can be a slot-die coater, gravure coater, electrostatic spray deposition coater, dry roll-to-roll coater, or combinations thereof.

In some embodiments, the electrode slurry can include electrode active materials, conductive carbon material, binders, solvents, and/or other additives. In some embodiments, the solvent content in the electrode slurries disclosed herein is less than a typical electrode slurry used in an electrode manufacturing process. As such, in some embodiments, the electrode slurries disclosed herein can be high solids content slurries. In some embodiments, the electrode slurry has at least about 40% solids by mass, at least about 45% solids by mass, at least about 50% solids by mass, at least about 55% solids by mass, at least about 60% solids by mass, or at least about 65% solids by mass. In some embodiments, the electrode slurry has at most about 90% solids by mass, at most about 85% solids by mass, at most about 80% solids by mass, at most about 75% solids by mass, or at most about 70% solids by mass. In some embodiments, the electrode slurry has about 40-70% solids by mass, about 45-70% solids by mass, or about 50-65% solids by mass.

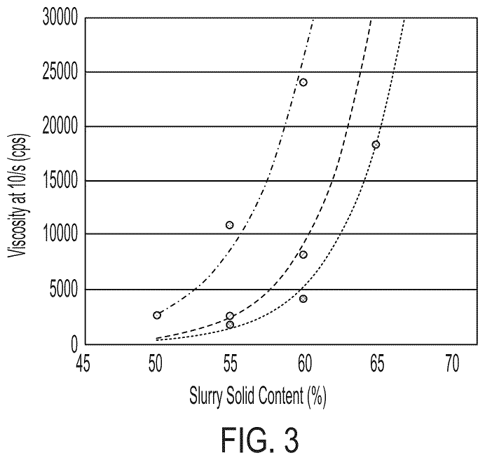

Reducing the solvent can reduce the abatement systems required for toxic solvents such as NMP, thereby reducing factory footprint. In addition, the lower the solvent content, the lower the oven/dryer energy requirement is to remove the solvent when drying the coated electrode substrates. However, lowering the solvent content can increase the viscosity of the electrode slurry, thereby making it more difficult to coat the electrode substrate with it. In addition, increasing the viscosity can make the electrode slurry inherently difficult to handle (e.g., store, convey, coat, etc.). For example, FIG. 3 illustrates an example of three different electrode slurries with different concentrations of viscosity reduction additive and how viscosity is affected as the solids content increases. As shown in FIG. 3, as the solid content of the electrode slurry increases, the viscosity exponentially increases. For example, a 10% increase in slurry solids content (e.g., 50% to 60%), can yield a massive increase in viscosity (e.g., 2500 cPs to 25,000 cPs).

In some embodiments, to reduce the viscosity of the electrode slurries disclosed herein, the electrode slurry coater can be a heated coater (e.g., a heated slot-die coater). In some embodiments, the heated coater can be configured to perform cartridge heating. In some embodiments, the heated coater can include high specific heat coefficient materials to compress the heated coater (e.g., heated slot-die) to minimize warpage.

In some embodiments, to reduce the viscosity of the electrode slurries disclosed herein, the electrode slurry can include at least one dispersant. In some embodiments, the electrode slurry can have about 0.1-1 wt. % at least one dispersant. In some embodiments, the at least one dispersant can be a thermoplastic urethane. In some embodiments, the viscosity of the electrode slurries during coating can be about 5,000-25,000 or about 10,000-20,000 cP at 10 s⁻¹ shear rate.

In some embodiments, the electrode active materials of the electrode slurry can include cathode active materials and/or anode active materials. In some embodiments, the cathode active materials can include high-nickel content (greater than or equal to 80% Ni) lithium transition metal oxide like a particulate lithium nickel manganese cobalt oxide (“LiNMC”), lithium nickel cobalt aluminum oxide (“LiNCA”), lithium nickel manganese cobalt aluminum oxide (“LiNMCA”), lithium metal phosphates like lithium iron phosphate (“LFP”), Lithium iron manganese phosphate (“LMFP”), and combinations thereof. In some embodiments, the cathode active materials can include sulfur containing cathode active materials such as Lithium Sulfide (Li2S), lithium polysulfides, Titanium Disulfide (TiS2), and combinations thereof. In some embodiments, the anode active materials can include graphitic carbon (e.g., ordered or disordered carbon with sp2 hybridization, artificial or natural Graphite, or blended), Li metal anode, silicon-based anode (e.g., silicon-based carbon composite anode, silicon metal, oxide, carbide, pre-lithiated), silicon-based carbon composite anode, lithium alloys (e.g., Li—Mg, Li—Al, Li—Ag alloy), lithium titanate, or combinations thereof. In some embodiments, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell does not comprise an anode active material in an uncharged state.

In some embodiments, the conductive carbon material of the electrode slurry can include graphite, carbon black, carbon nanotubes, Super P carbon black material, Ketjen Black, Acetylene Black, SWCNT, MWCNT, carbon nanofiber, graphene, and combinations thereof. In some embodiments, the binders of the electrode slurry can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”), carboxymethylcellulose (“CMC”), agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (Plpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or combinations thereof.

After at least one side of the electrode substrate is coated with an electrode slurry, the coated electrode substrate can be dried in a multi-pass dryer or oven 207. Advantageously, a high viscosity electrode slurry can enable aggressive (i.e., faster) drying profiles with higher temperatures, higher airflow rates, and/or the use of multiple heating methods (e.g., convective, inductive, infrared, etc.).

In some embodiments, drying the coated electrode substrate includes moving the coated electrode substrate along a web path that changes direction multiple times within the dryer before exiting the dryer. In some embodiments, the multi-pass dryer (i.e., 2 or more passes) can be configured to dry the coated electrode substrate. In some embodiments, the coated electrode substrate can be passed through the same dryer footprint multiple times. In some embodiments, a web path length of the coated electrode substrate in the dryer at a given time is greater than a footprint length (FL) of the dryer. For example, the web path length of the coated electrode substrate in the dryer 201 of FIG. 2 can be the length of the web path from inlet 208 to outlet 211 plus inlet 223 to outlet 224.

In some embodiments, a ratio of the web path length of the coated electrode substrate in the dryer at a given time to the footprint length of the dryer is about 2:1 to 15:1, about 2:1 to 10:1, about 2:1 to 6:1, about 3:1 to 5:1, or about 4:1. For example, in a 2:1 web path length to footprint length ratio for a 1 meter footprint length oven, 2 meters of the coated electrode substrate can be dried (i.e., 2 meters of the coated electrode are in the dryer/oven at a given time). In some embodiments, the web path of the coated electrode can be horizontally stacked and/or vertically stacked within the dryer as shown in FIG. 2. In some embodiments, the web path length is the entire web path length of the electrode substrate in the dryer at a given time (i.e., includes both single and dual-side coated electrode web paths) (e.g., the length of the web path from inlet 208 to outlet 211 plus inlet 223 to outlet 224).

In some embodiments, the multi-pass dryer/oven can include an inlet 208 configured to receive the coated electrode substrate. In some embodiments, the multi-pass dryer includes a plurality of rollers 206 configured to move the coated electrode substrate along at least a portion of the web path that changes direction multiple times within the dryer. In some embodiments, the multi-pass dryer/oven can include an outlet 211 configured to discharge the dried coated electrode substrate 212. In some embodiments, the dried electrode substrate can have an electrode layer on at least one side of the electrode substrate that the electrode slurry was deposited. In some embodiments, an electrode layer can have an electrode active material of about 90-99.9 wt. %, about 91-99 wt. %, about 93-99 wt. %, about 94-99 wt. %, about 95-99 wt %, or about 95-97 wt. % of the electrode layer. In some embodiments, an electrode layer can have binders of about 0.1-5 wt. %, about 0.5-4 wt. % or about 1-3 wt. % of the electrode layer. In some embodiments, an electrode layer can have a conductive carbon material of about 0.1-6 wt. %, about 0.5-3 wt. %, or about 1.5-2.5 wt. % of the electrode layer. In some embodiments, an electrode layer loading on the lithium coated current collector can be about 5-30 mg/cm², about 10-25 mg/cm², about 12-22 mg/cm², or about 15-20 mg/cm².

In some embodiments, at least one first portion 209a of the web path can move in a first direction in the dryer. In some embodiments, at least one second portion 209b of the web path can move in a second direction in the dryer. In some embodiments, the first direction is different from the second direction. In some embodiments, the first direction is opposite the second direction. In some embodiments, the at least one first portion of the web path and the at least one second portion of the web path can be parallel to one another. In some embodiments, a at least one third portion 209c of the web path can move in a third direction in the dryer. In some embodiments, the third direction is the same as the first direction. In some embodiments, the third direction is the opposite direction of the second direction. In some embodiments, at least two of the first, second, and third portions of the web path can be parallel to one another. In some embodiments, at least two of the first, second, and third portions of the web path can be vertically and/or horizontally stacked with respect to one another. In some embodiments, the first, second, and/or third portions of the web path can refer to the web path in a section of the dryer (e.g., first and/or second sections 210a and 210b). In some embodiments, there can be as many portions of the web path as there are passes in the multi-pass dryer/oven.

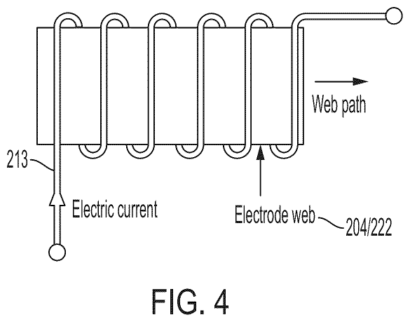

In some embodiments, the multi-pass dryer/oven includes at least one inductive heating source configured to heat at least one portion of the web path of the coated electrode substrate in the dryer. In some embodiments, the multi-pass dryer includes a plurality of inductive heating sources configured to heat one or multiple portions of the web path of the coated electrode substrate in the dryer. In some embodiments, the at least one inductive heating source includes an induction coil 213. In some embodiments, the induction coil(s) can be wrapped around at least a portion of the coated electrode substrate as it moves along a portion of the web path in the dryer. For example, FIG. 4 illustrates induction coil 213 wrapped around coated electrode substrate 204 as it moves along its web path.

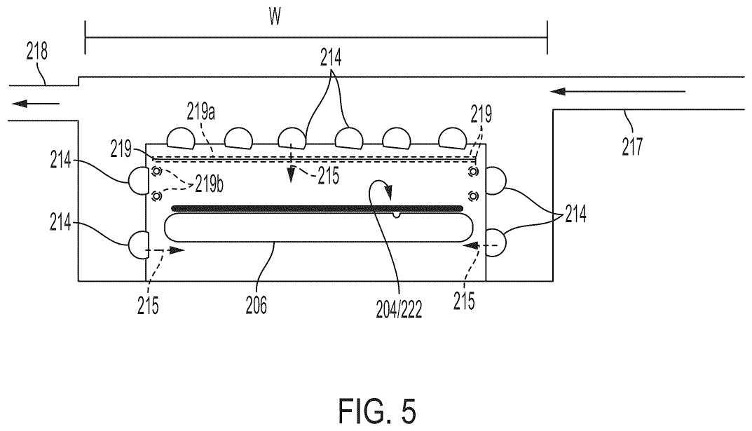

In some embodiments, the multi-pass dryer/oven includes at least one convective heating nozzle 214 configured to direct a flow 215 of heated gas (e.g., air) toward at least a portion of the web path of the coated electrode substrate in the dryer. In some embodiments, the multi-pass dryer includes a plurality of convective heating nozzles configured to direct a flow of heat gas towards one or multiple portions of the web path of the coated electrode substrate in the dryer. FIG. 5 illustrates an example cross section of a top-down view of dryer location 216 indicated in FIG. 2. As shown in FIG. 5, heated gas (e.g., air) can enter the dryer through inlet 217 and the oven plenum (e.g., heated gas) can be discharged through the at least one convective heating nozzle 214 toward the portion of the web path of the coated electrode substrate in the dryer. In some embodiments, exhaust gas can exit the dryer through exhaust outlet 218.

In some embodiments, the multi-pass dryer/oven includes at least one infrared heat source 219 configured to heat at least a portion of the web path of the coated electrode substrate in the dryer. In some embodiments, the multi-pass dryer includes a plurality of infrared heat sources configured to heat one or multiple portions of the web path of the coated electrode substrate in the dryer. In some embodiments, the infrared heat sources can be an infrared heating tube. In some embodiments, the infrared heat source(s) can be positioned vertically and/or horizontally in the multi-pass dryer. In some embodiments, the infrared heat source(s) can be positioned in the lengthwise direction of the multi-pass dryer, the widthwise direction of the multi-pass dryer, and/or the height wise direction (e.g., vertically) in the multi-pass dryer. For example, FIG. 5 illustrates infrared heat tube 219a positioned in the widthwise W direction of the multi-pass dryer and a plurality of infrared tubes 219b positioned in the height wise direction H (or vertical direction) of the multi-pass dryer.

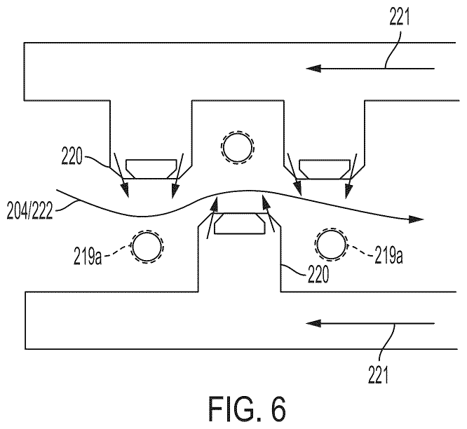

In some embodiments, the multi-pass dryer/oven includes at least one floatation heating nozzle 220 configured to heat and float at least a portion of the web path of the coated electrode substrate with a heated gas 221 (e.g., air) in the dryer. In some embodiments, the multi-pass dryer includes a plurality of floatation heating nozzles configured to heat and float one or multiple portions of the web path of the coated electrode substrate with a heated gas in the dryer. In some embodiments, the at least one floatation nozzle can keep the coated electrode substrate floating as it moves along one or more portions of its web path in the dryer. For example, FIG. 6 illustrates a plurality of floatation heating nozzles 220 that keeps the coated electrode substrate 204 afloat as it moves along a portion of its web path in the dryer.

In some embodiments, the multi-pass dryer/oven can include a first section 210a. In some embodiments, the multi-pass dryer/oven can include multiple sections (e.g., section 210a and section 210b). In some embodiments, the first section is where an electrode slurry can be dried on a first side of the electrode substrate. In some embodiments, drying the coated electrode substrate in the first section includes moving the coated electrode substrate along a web path that changes direction multiple times within the first section of the dryer before exiting the dryer. In some embodiments, the coated electrode substrate can be passed through the same dryer footprint multiple times in the section of the dryer. In some embodiments, a web path length of the coated electrode substrate in the first section of the dryer at a given time is greater than a footprint length (FL) of the dryer. For example, a web path length of the coated electrode substrate in the first section of the dryer of FIG. 2 is the length of the web path from inlet 208 to outlet 211. In some embodiments, a ratio of the web path length of the coated electrode substrate in the first section of the dryer at a given time to the footprint length of the dryer is about 2:1 to 10:1, about 2:1 to 5:1, about 2:1 to 4:1, or about 3:1. In some embodiments, one or more sections of the dryer can include any of the heating sources (e.g., inductive heating source, infrared heating source, convective heating source/nozzle, floatation heating source/nozzle, etc., or combinations thereof) disclosed herein to heat one or more portions of the web path in the one or more sections.

In some embodiments, after the coated electrode substrate is dried, it can exit the multi-pass dryer. In some embodiments, the dried coated electrode substrate can be rewound into a roll via rewinder. In some embodiments, a second side opposite the coated first side of the dried coated electrode substrate 212 can be coated with an electrode slurry to form a dual-side coated electrode substrate 222. In some embodiments, the electrode slurry can be any electrode slurry disclosed herein. In some embodiments, the electrode slurry for the second coating is the same as the electrode slurry used to coat the first side of the electrode substrate.

After the dual-side coated electrode substrate is coated with an electrode slurry, the dual-side coated electrode substrate can be dried in the same or different multi-pass dryer or oven as the first side was dried. In some embodiments, drying the dual-side coated electrode substrate includes moving the dual-side coated electrode substrate along a web path that changes direction multiple times within the dryer before exiting the dryer. In some embodiments, the multi-pass dryer (i.e., 2 or more passes) can be configured to dry the dual-side coated electrode substrate. In some embodiments, the dual-side coated electrode substrate can be passed through the same dryer footprint multiple times. In some embodiments, a web path length of the dual-side coated electrode substrate in the dryer at a given time is greater than a footprint length (FL) of the dryer. In some embodiments, a ratio of the web path length of the dual-side coated electrode substrate in the dryer at a given time to the footprint length of the dryer is about 2:1 to 15:1, about 2:1 to 10:1, about 2:1 to 6:1, about 2:1 to 4:1, or about 3:1. In some embodiments, the web path of the dual-side coated electrode substrate can be horizontally stacked and/or vertically stacked within the dryer as shown in FIG. 2.

In some embodiments, the multi-pass dryer/oven can include a second inlet 223 configured to receive the dual-side coated electrode substrate. In some embodiments, the multi-pass dryer includes a plurality of rollers 206 configured to move the dual-side coated electrode substrate along at least a portion of the web path that changes direction multiple times within the dryer. In some embodiments, the multi-pass dryer/oven can include a second outlet 224 configured to discharge the dried dual-side coated electrode substrate 225. In some embodiments, the dried dual-side coated electrode substrate can be rewound into a roll (via rewinder 226). In some embodiments, the dried coated electrode substrate or the dried dual-side coated electrode substrate can be an electrode film.

In some embodiments, the dried dual-side coated electrode substrate can have a second electrode layer on the side of the electrode substrate where the second electrode slurry was deposited. In some embodiments, this second electrode layer can have an electrode active material of about 90-99.9 wt. %, about 91-99 wt. %, about 93-99 wt. %, about 94-99 wt. %, about 95-99 wt %, or about 95-97 wt. % of the electrode layer. In some embodiments, the second electrode layer can have binders of about 0.1-5 wt. %, about 0.5-4 wt. % or about 1-3 wt. % of the electrode layer. In some embodiments, the second electrode layer can have a conductive carbon material of about 0.1-6 wt. %, about 0.5-3 wt. %, or about 1.5-2.5 wt. % of the electrode layer. In some embodiments, the second electrode layer loading on the lithium coated current collector can be about 5-30 mg/cm², about 10-25 mg/cm², about 12-22 mg/cm², or about 15-20 mg/cm².

In some embodiments, at least one portion 209d of the web path of the dual-side coated electrode substrate can move in a first direction in the dryer. In some embodiments, at least one second portion 209e of the web path of the dual-side coated electrode substrate can move in a second direction in the dryer. In some embodiments, the first direction is different from the second direction. In some embodiments, the first direction is opposite the second direction. In some embodiments, the at least one first portion of the web path of the dual-side coated electrode substrate and the at least one second portion of the web path can be parallel to one another. In some embodiments, at least one third portion 209f of the web path of the dual-side coated electrode substrate can move in a third direction in the dryer. In some embodiments, the third direction is the same as the first direction. In some embodiments, the third direction is the opposite direction of the second direction. In some embodiments, at least two of the first, second, and third portions of the web path of the dual-side coated electrode substrate can be parallel to one another. In some embodiments, at least two of the first, second, and third portions of the web path of the dual-side coated electrode substrate can be vertically and/or horizontally stacked with respect to one another. In some embodiments, the first, second, and/or third portions of the web path can refer to the web path in the second section 210b.

Similar to the above with respect to the coated electrode substrate, the dual-side coated electrode substrate can be heated/dried with any of the heat sources disclosed herein. In addition, the dual-side coated electrode substrate can be heated/dried in the same manners used with any of the heat sources described above with respect to the coated electrode substrate (i.e., convective heating, infrared heating, floatation heating, inductive heating, or combinations thereof).

In some embodiments, the multi-pass dryer/oven includes at least one inductive heating source configured to heat at least one portion of the web path of the dual-side coated electrode substrate in the dryer. In some embodiments, the multi-pass dryer includes a plurality of inductive heating sources configured to heat one or multiple portions of the web path of the dual-side coated electrode substrate in the dryer. In some embodiments, the multi-pass dryer/oven includes at least one convective heating nozzle configured to direct a flow of heated gas (e.g., air) toward at least a portion of the web path of the dual-side coated electrode substrate in the dryer. In some embodiments, the multi-pass dryer includes a plurality of convective heating nozzles configured to direct a flow of heat gas towards one or multiple portions of the web path of the dual-side coated electrode substrate in the dryer. In some embodiments, the multi-pass dryer/oven includes at least one infrared heat source configured to heat at least a portion of the web path of the dual-side coated electrode substrate in the dryer. In some embodiments, the multi-pass dryer includes a plurality of infrared heat sources configured to heat one or multiple portions of the web path of the dual-side coated electrode substrate in the dryer. In some embodiments, the multi-pass dryer/oven includes at least one floatation heating nozzle configured to heat and float at least a portion of the web path of the dual-side coated electrode substrate with a heated gas (e.g., air) in the dryer. In some embodiments, the multi-pass dryer includes a plurality of floatation heating nozzles configured to heat and float one or multiple portions of the web path of the dual-side coated electrode substrate with a heated gas in the dryer. In some embodiments, the at least one floatation nozzle can keep the dual-side coated electrode substrate floating as it moves along one or more portions of its web path in the dryer.

In some embodiments, the multi-pass dryer/oven can include a second section 210b. In some embodiments, the second section is where an electrode slurry can be dried on a second side of the electrode substrate opposite the side with the first electrode slurry. In some embodiments, drying the dual-side coated electrode substrate in the second section includes moving the dual-side coated electrode substrate along a web path that changes direction multiple times within the second section of the dryer before exiting the dryer. In some embodiments, the dual-side coated electrode substrate can be passed through the same dryer footprint multiple times in the section of the dryer. In some embodiments, a web path length of the dual-side coated electrode substrate in the second section of the dryer at a given time is greater than a footprint length (FL) of the dryer. For example, a web path length of the dual-side coated electrode substrate in the second section of the dryer in FIG. 2 is the length of the web path from inlet 223 to outlet 224.

In some embodiments, a ratio of the web path length of the dual-side coated electrode substrate in the second section of the dryer at a given time to the footprint length of the dryer is about 2:1 to 10:1, about 2:1 to 5:1, about 2:1 to 4:1, or about 3:1. In some embodiments, the second section of the dryer can include any of the heating sources (e.g., inductive heating source, infrared heating source, convective heating source/nozzle, floatation heating source/nozzle, etc., or combinations thereof) disclosed herein to heat one or more portions of the web path in the second section.

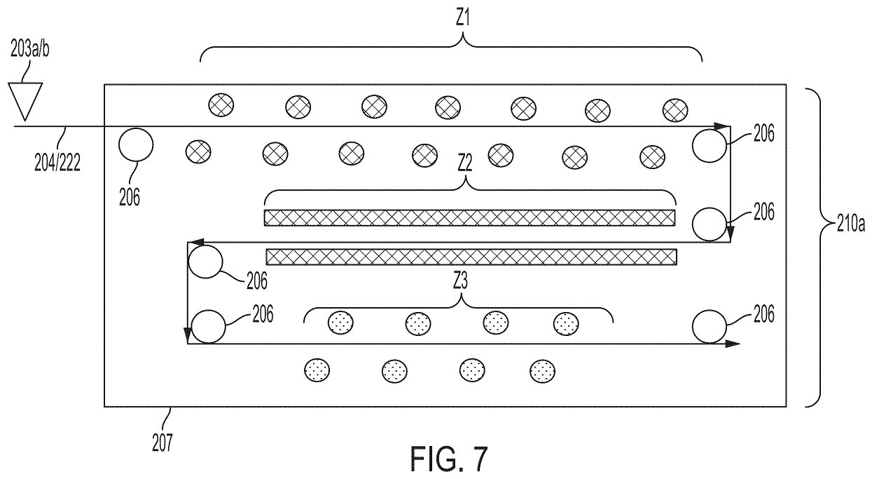

In some embodiments, the multi-pass dryer/oven can include multiple heating and/or cooling zones, wherein a portion of the coated electrode substrate can be heated and/or cooled. In some embodiments, the heating zone(s) can include any of the heating sources (e.g., inductive heating source, infrared heating source, convective heating source/nozzle, floatation heating source/nozzle, etc., or combinations thereof) disclosed herein to heat one or more portions of the web path. For example, FIG. 7 illustrates a section 210a (or 210b) of a multi-pass dryer. The section can include heating zones Z1 and Z2 and cooling zone Z3. In some embodiments, heating zone Z1 can be ramp heating zone where the heat to the coated electrode substrate can increase as it moves along its web path through heating zone Z1. In some embodiments, heating zone Z2 can be a controlled hold heating zone where the heat to the coated electrode substrate is held relatively constant as it moves along its web path through heating zone Z2. In some embodiments, cooling zone Z3 can cool the coated electrode substrate as it moves along its web path through cooling zone Z3 towards the outlet. In some embodiments, the cooling zone(s) can include any cooling source (e.g., convective cooling source that is configured to direct cool gas (e.g., air) towards the coated electrode substrate, or cooled rollers, among others). In some embodiments, the cooled rollers can be rollers with chilled water passing through which can carry the electrode film while also cooling it.

### Battery Cells, Battery Modules, Battery Packs, and Electric Vehicle Systems

After the dried coated electrode substrate or the dried dual-side coated electrode substrate (e.g., electrode film) has been created, it can be inserted into a battery cell, which can be used as an electrical energy source. For example, the dried coated electrode substrates or the dried dual-side coated electrode substrates disclosed herein can be used as an electrode layer or film (e.g., cathode or anode layer or film).

Reference will now be made to implementations and embodiments of various aspects and variations of battery cells, battery modules, battery packs, and the methods of making such battery cells, battery modules, and battery packs. Although several exemplary variations of the battery cells, modules, packs, and methods of making them are described herein, other variations of the battery cells, modules, packs and methods may include aspects of the battery cells, modules, packs and methods described herein combined in any suitable manner having combinations of all or some of the aspects described. In addition, any part of or any of the coated electrode substrates, dual-side coated electrode substrates, electrodes, densified electrodes, components, systems, methods, apparatuses, devices, compositions, etc. described herein can be implemented into the battery cells, battery modules, battery packs, and methods of making these battery cells, battery modules, and battery packs.

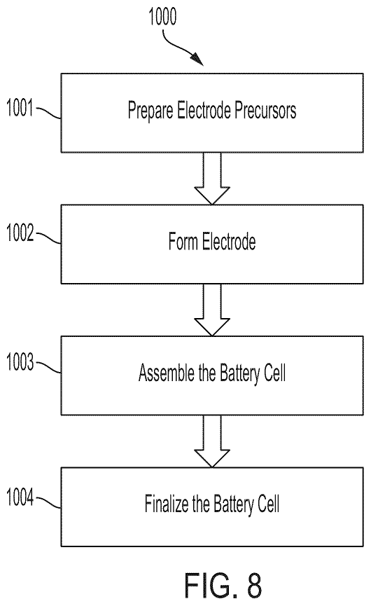

FIG. 8 illustrates a flow chart for a typical battery cell manufacturing process 1000. These steps are not exhaustive and other battery cell manufacturing processes can include additional steps or only a subset of these steps. At step 1001, the electrode precursors (e.g., binder, active material, conductive carbon additive) can be prepared. In some embodiments, this step can include mixing electrode materials (e.g., active materials) with additional components (e.g., binders, solvents, conductive additives, etc.) to form an electrode slurry. In some embodiment, this step can include synthesizing the electrode materials themselves.

At step 1002, the electrode can be formed. In some embodiments, this step can include coating an electrode slurry on at least one side of an electrode substrate to form coated electrode substrates or dried dual-side coated electrode substrates as described above.

After coating, the coated electrode substrate or dual-side coated electrode substrates can be dried to evaporate any solvent using any of the above described multi-pass dryers/ovens. In some embodiments, this step can include calendaring the coated current collectors. Calendaring can adjust the physical properties (e.g., bonding, conductivity, density, porosity, etc.) of the electrodes. In some embodiments, the electrode can then be sized via a slitting and/or notching machine to cut the electrode into the proper size and/or shape.

In some embodiments, solid electrolyte materials of the solid electrolyte layer can include inorganic solid electrolyte materials such as oxides, sulfides, phosphides, halides, ceramics, solid polymer electrolyte materials, hybrid solid state electrolytes, or glassy electrolyte materials, among others, or in any combinations thereof. In some embodiments, the solid electrolyte layer can include a polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B=Al, Ti), garnet-type with formula A₃B₂(XO₄)₃ (A=Ca, Sr, Ba and X=Nb, Ta), lithium phosphorous oxy-nitride (LixPOyNz), among others, or in any combinations thereof. In some embodiments, the solid electrolyte layer can include a glassy, ceramic and/or crystalline electrolyte material such as Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, lithium phosphorous oxy-nitride (LixPOyNz), lithium germanium phosphate sulfur (LiloGeP₂S₁₂), Yttria-stabilized Zirconia (YSZ), NASICON (Na₃Zr₂Si₂PO₁₂), beta-alumina solid electrolyte (BASE), perovskite ceramics (e.g., strontium titanate (SrTiO₃)), Lithium lanthanum zirconium oxide (La₃Li₇O₁₂Zr₂), Li SiCON (Li22+2xZn1−xGe04), lithium lanthanum titanate (Li3xLa2/3−xTiO3) and/or sulfide-based lithium argyrodites with formula Li₆PS₅X (X=Cl, Br) like Li₆PS₅Cl, among others, or in any combinations thereof. Furthermore, solid state polymer electrolyte materials can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), and PEG, among others, or in any combinations thereof.

At step 1003, the battery cell can be assembled. After the electrodes, separators, and/or electrolytes have been prepared, a battery cell can be assembled/prepared. In this step, the separator and/or an electrolyte layer can be assembled between the anode and cathode layers to form the internal structure of a battery cell. These layers can be assembled by a winding method such as a round winding or prismatic/flat winding, a stacking method, or a z-folding method.

The assembled cell structure can then be inserted into a cell housing which is then partially or completed sealed. In addition, the assembled structure can be connected to terminals and/or cell tabs (via a welding process). For battery cells utilizing a liquid electrolyte, the housed cell with the electrode structure inside it can also be filled with electrolyte and subsequently sealed.

Battery cells can have a variety of form factors, shapes, or sizes. For example, battery cells (and their housings/casings) can have a cylindrical, rectangular, square, cubic, flat, or prismatic form factor, among others. There are four main types of battery cells: (1) button or coin cells; (2) cylindrical cells; (3) prismatic cells; and (4) pouch cells. Battery cells can be assembled, for example, by inserting a winding and/or stacked electrode roll (e.g., a jellyroll) into a battery cell casing or housing. In some embodiments, the winded or stacked electrode roll can include the electrolyte material. In some embodiments, the electrolyte material can be inserted in the battery casing or housing separate from the electrode roll. In some embodiments, the electrolyte material includes, but is not limited to, an ionically conductive fluid or other material (e.g., a layer) that can allow the flow of electrical charge (i.e., ion transportation) between the cathode and anode. In some embodiments, the electrolyte material can include a non-aqueous polar solvent (e.g., a carbonate such as ethylene carbonate, propylene carbonate, diethyl carbonate, ethyl methyl carbonate, dimethyl carbonate, or a mixture of any two or more thereof). The electrolytes may also include other additives such as, but not limited to, vinylidene carbonate, fluoroethylene carbonate, ethyl propionate, methyl propionate, methyl acetate, ethyl acetate, or a mixture of any two or more thereof. The lithium salt of the electrolyte may be any of those used in lithium battery construction including, but not limited to, lithium perchlorate, lithium hexafluorophosphate, lithium bis(fluorosulfonyl)imide, lithium bis(trifluorosulfonyl)imide, or a mixture of any two or more thereof. In addition, the salt may be present in the electrolyte from greater than 0 M to about 5 M, or for example salt may be present between about 0.05 to 2 M or about 0.1 to 2 M.

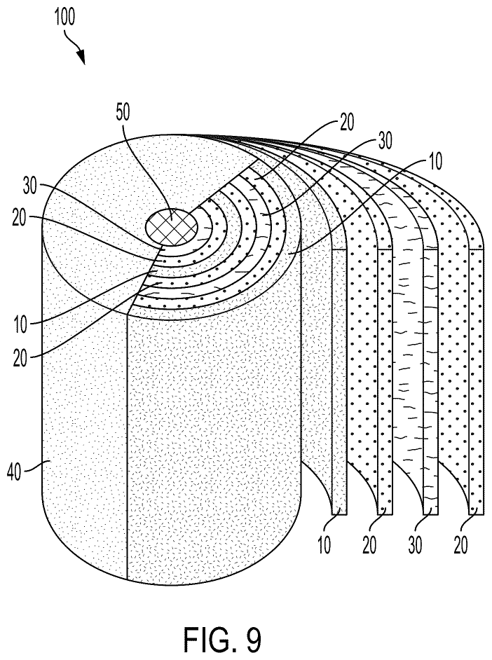

FIG. 9 depicts an illustrative example of a cross sectional view of a cylindrical battery cell 100. The cylindrical battery cell can include layers (e.g., sheet-like layers) of anode layers 10, separator and/or electrolyte layers 20, and cathode layers 30.

A battery cell can include at least one anode layer, which can be disposed within the cavity of the housing/casing. The battery cell can also include at least one cathode layer. The at least one cathode layer can also be disposed within the housing/casing. In some embodiments, when the battery cell is discharging (i.e., providing electric current), the at least one anode layer releases ions (e.g., lithium ions) to the at least one cathode layer generating a flow of electrons from one side to the other. Conversely, in some embodiments, when the battery cell is charging, the at least one cathode layer can release ions and the at least one anode layer can receive these ions.

These layers (cathode, anode, separator/electrolyte layers) can be sandwiched, rolled up, and/or packed into a cavity of a cylinder-shaped casing 40 (e.g., a metal can). The casings/housings can be rigid such as those made from metallic or hard-plastic, for example. In some embodiments, a separator layer (and/or electrolyte layer) 20 can be arranged between an anode layer 10 and a cathode layer 30 to separate the anode layer 20 and the cathode layer 30. In some embodiments, the layers in the battery cell can alternate such that a separator layer (and/or electrolyte layer) separates an anode layer from a cathode layer. In other words, the layers of the battery electrode can be (in order) separator layer, anode/cathode layer, separator layer, opposite of other anode/cathode layer and so on. The separator layer (and/or electrolyte layer) 20 can prevent contact between the anode and cathode layers while facilitating ion (e.g., lithium ions) transport in the cell. The battery cell can also include at least one terminal 50. The at least one terminal can be electrical contacts used to connect a load or charger to a battery cell. For example, the terminal can be made of an electrically conductive material to carry electrical current from the battery cell to an electrical load, such as a component or system of an electric vehicle as discussed further herein.

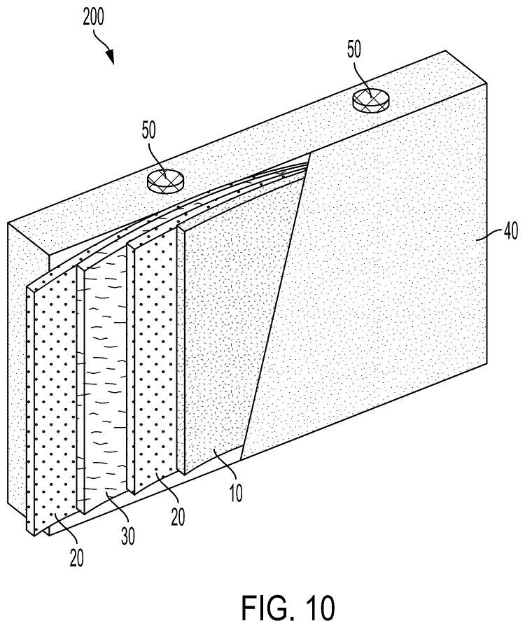

FIG. 10 depicts an illustrative example of a cross sectional view of a prismatic battery cell 200. The prismatic battery cell can include layers (e.g., sheet-like layers) of anode layers 10, separator and/or electrolyte layers 20, and cathode layers 30. Similar to the cylindrical battery cell, the layers of a prismatic battery cell can be sandwiched, rolled, and/or pressed to fit into cubic or rectangular cuboid (e.g., hyperrectangle) shaped casing/housing 40. In some embodiments, the layers can be assembled by layer stacking rather than jelly rolling. In some embodiments, the casing or housing can be rigid such as those made from a metal and/or hard-plastic. In some embodiments, the prismatic battery cell 200 can include more than one terminal 50. In some embodiments, one of these terminals can be the positive terminal and the other a negative terminal. These terminals can be used to connect a load or charger to the battery cell.

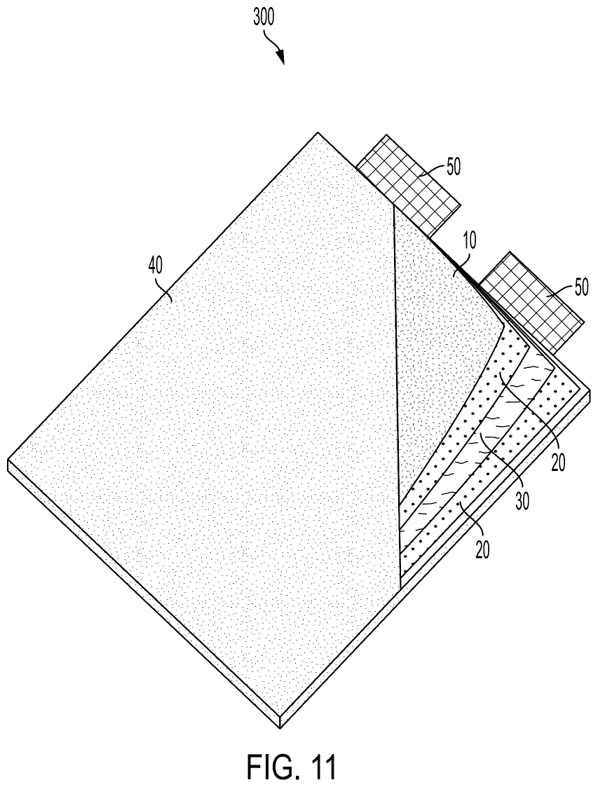

FIG. 11 depicts an illustrative example of a cross section view of a pouch battery cell 300. The pouch battery cells do not have a rigid enclosure and instead use a flexible material for the casing/housing 40. This flexible material can be, for example, a sealed flexible foil. The pouch battery cell can include layers (e.g., sheet-like layers) of anode layers 10, separator and/or electrolyte layers 20, and cathode layers 30. In some embodiments, these layers are stacked in the casing/housing. In some embodiments, the pouch battery cell 200 can include more than one terminal 50. In some embodiments, one of these terminals can be the positive terminal and the other the negative terminal. These terminals can be used to connect a load or charger to the battery cell.

The casings/housings of battery cells can include one or more materials with various electrical conductivity or thermal conductivity, or a combination thereof. In some embodiments, the electrically conductive and thermally conductive material for the casing/housing of the battery cell can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. In some embodiments, the electrically conductive and thermally conductive material for the housing of the battery cell can include a ceramic material (e.g., silicon nitride, silicon carbide, titanium carbide, zirconium dioxide, beryllium oxide, and among others) and/or a thermoplastic material (e.g., polyethylene, polypropylene, polystyrene, polyvinyl chloride, or nylon), among others.

At step 1004, the battery cell can be finalized. In some embodiments, this step includes the formation process wherein the first charging and discharging process for the battery cell takes place. In some embodiments, this initial charge and discharge can form a solid electrolyte interface between the electrolyte and the electrodes. In some embodiments, this step may cause some of the cells to produce gas which can be removed in a degassing process from the battery cell. In some embodiments, this step includes aging the battery cell. Aging can include monitoring cell characteristics and performance over a fixed period of time. In some embodiments, this step can also include testing the cells in an end-of-line (EOL) test rig. The EOL testing can include discharging the battery cells to the shipping state of charge, pulse testing, testing internal resistance measurements, testing OCV, testing for leakage, and/or optically inspecting the battery cells for deficiencies.

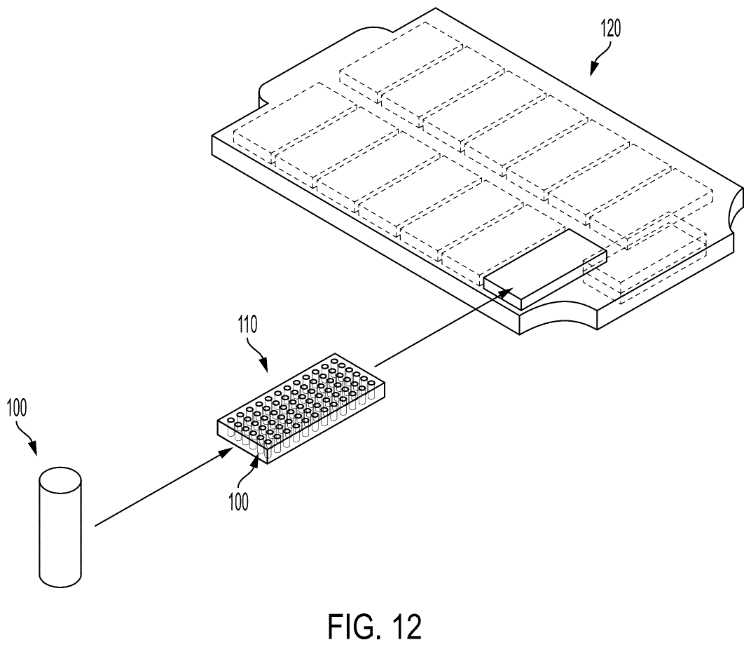

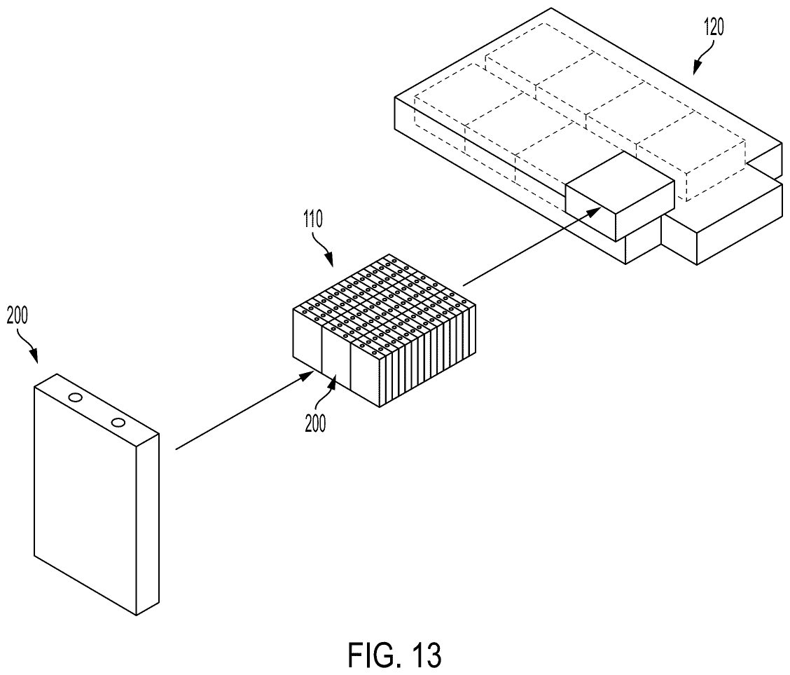

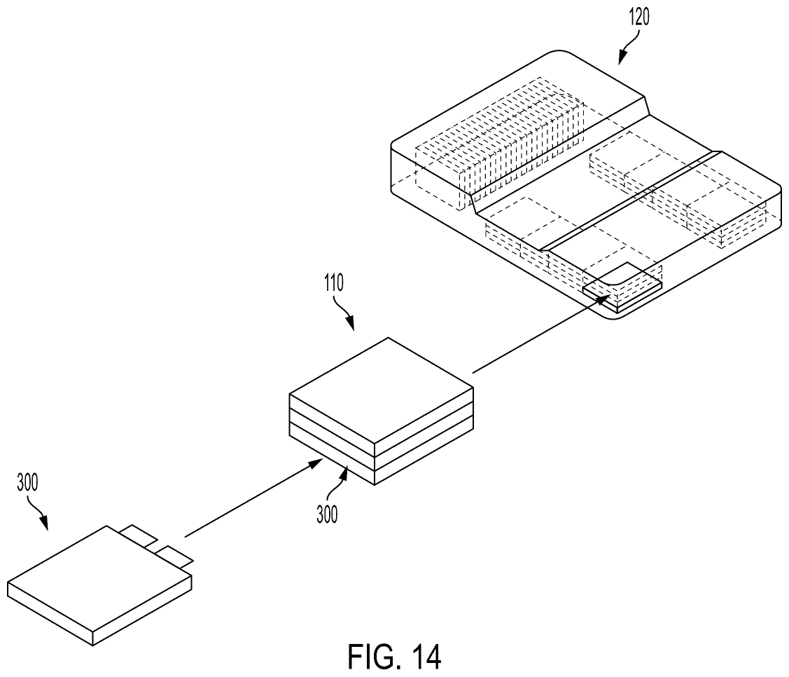

A plurality of battery cells (100, 200, and/or 300) can be assembled or packaged together in the same housing, frame, or casing to form a battery module and/or battery pack. The battery cells of a battery module can be electrically connected to generate an amount of electrical energy. These multiple battery cells can be linked to the outside of the housing, frame, or casing, through a uniform boundary. The battery cells of the battery module can be in parallel, in series, or in a series-parallel combination of battery cells. The housing, frame, or casing can protect the battery cells from a variety of dangers (e.g., external elements, heat, vibration, etc.). FIG. 12 illustrates cylindrical battery cells 100 being inserted into a frame to form battery module 112. FIG. 13 illustrates prismatic battery cells 200 being inserted into a frame to form battery module 112. FIG. 14 illustrates pouch battery cells 300 being inserted into a frame to form battery module 112. In some embodiments, the battery pack may not include modules. For example, the battery pack can have a “module-free” or cell-to-pack configuration wherein battery cells are arranged directly into a battery pack without assembly into a module.

A plurality of the battery modules 112 can be disposed within another housing, frame, or casing to form a battery pack 120 as shown in FIGS. 12-14. In some embodiments, a plurality of battery cells can be assembled, packed, or disposed within a housing, frame, or casing to form a battery pack (not shown). In such embodiments, the battery pack may not include a battery module (e.g., module-free). For example, the battery pack can have a module-free or cell-to-pack configuration where the battery cells can be arranged directly into a battery pack without assembly into a battery module. In some embodiments, the battery cells of the battery pack can be electrically connected to generate an amount of electrical energy to be provided to another system (e.g., an electric vehicle).

The battery modules of a battery pack can be electrically connected to generate an amount of electrical energy to be provided to another system (e.g., an electric vehicle). The battery pack can also include various control and/or protection systems such as a heat exchanger system (e.g., a cooling system) configured to regulate the temperature of the battery pack (and the individual modules and battery cells) and a battery management system configured to control the battery pack's voltage, for example. In some embodiments, a battery pack housing, frame, or casing can include a shield on the bottom or underneath the battery modules to protect the battery modules from external elements. In some embodiments, a battery pack can include at least one heat exchanger (e.g., a cooling line configured to distribute fluid through the battery pack or a cold plate as part of a thermal/temperature control or heat exchange).

In some embodiments, battery modules can collect current or electrical power from the individual battery cells that make up the battery modules and can provide the current or electrical power as output from the battery pack. The battery modules can include any number of battery cells and the battery pack can include any number of battery modules. For example, the battery pack can have one, two, three, four, five, six, seven, eight, nine, ten, eleven, twelve or other number of battery modules disposed in the housing/frame/casing. In some embodiments, a battery module can include multiple submodules. In some embodiments, these submodules may be separated by a heat exchanger configured to regulate or control the temperature of the individual battery module. For example, a battery module can include a top battery submodule and a bottom battery submodule. These submodules can be separated by a heat exchanger such as a cold plate in between the top and bottom battery submodules.

The battery packs can come in all shapes and sizes. For example, FIGS. 12-14 illustrates three differently shaped battery packs 120. As shown in FIGS. 12-14, the battery packs 120 can include or define a plurality of areas, slots, holders, containers, etc. for positioning of the battery modules. The battery modules can come in all shapes and sizes. For example, the battery modules can be square, rectangular, circular, triangular, symmetrical, or asymmetrical. In some examples, battery modules in a single battery pack may be shaped differently. Similarly, the battery module can include or define a plurality of areas, slots, holders, containers, etc. for the plurality of battery cells.

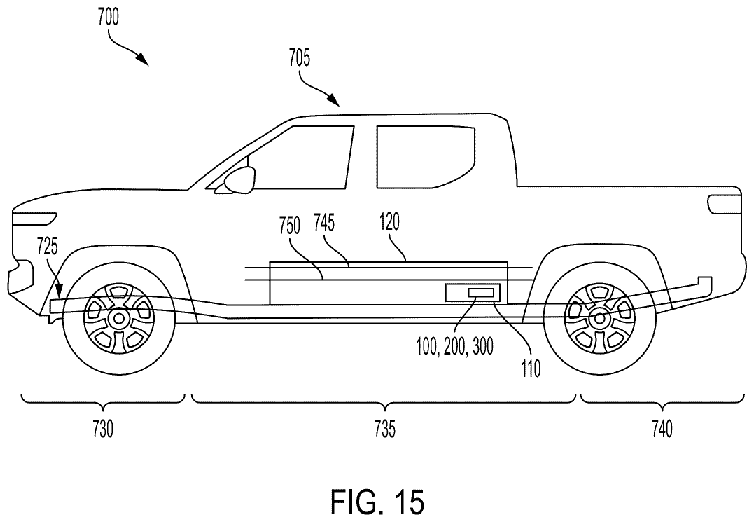

FIG. 15 illustrates an example of a cross sectional view 700 of an electric vehicle 705 that includes at least one battery pack 120. Electric vehicles can include, but are not limited to, electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. Electric vehicles can be fully electric or partially electric (e.g., plug-in hybrid) and further, electric vehicles can be fully autonomous, partially autonomous, or unmanned. In addition, electric vehicles can also be human operated or non-autonomous.

Electric vehicles 705 can be installed with a battery pack 120 that includes battery modules 112 with battery cells (100, 200, and/or 300) to power the electric vehicles. The electric vehicle 705 can include a chassis 725 (e.g., a frame, internal frame, or support structure). The chassis 725 can support various components of the electric vehicle 705. In some embodiments, the chassis 725 can span a front portion 730 (e.g., a hood or bonnet portion), a body portion 735, and a rear portion 740 (e.g., a trunk, payload, or boot portion) of the electric vehicle 705. The battery pack 120 can be installed or placed within the electric vehicle 705. For example, the battery pack 120 can be installed on the chassis 725 of the electric vehicle 705 within one or more of the front portion 730, the body portion 735, or the rear portion 740. In some embodiments, the battery pack 120 can include or connect with at least one busbar, e.g., a current collector element. For example, the first busbar 745 and the second busbar 750 can include electrically conductive material to connect or otherwise electrically couple the battery pack 120 (and/or battery modules 112 or the battery cells 100, 200, and/or 300) with other electrical components of the electric vehicle 705 to provide electrical power to various systems or components of the electric vehicle 705. In some embodiments, battery pack 120 can also be used as an energy storage system to power a building, such as a residential home or commercial building instead of or in addition to an electric vehicle.

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

Reference to “about” a value or parameter herein includes (and describes) variations that are directed to that value or parameter per se. For example, description referring to “about X” includes description of “X”. In addition, reference to phrases “less than”, “greater than”, “at most”, “at least”, “less than or equal to”, “greater than or equal to”, or other similar phrases followed by a string of values or parameters is meant to apply the phrase to each value or parameter in the string of values or parameters.

This application discloses several numerical ranges in the text and figures. The numerical ranges disclosed inherently support any range or value within the disclosed numerical ranges, including the endpoints, even though a precise range limitation is not stated verbatim in the specification because this disclosure can be practiced throughout the disclosed numerical ranges.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A system comprising:
a coater configured to coat a side of an electrode substrate with an electrode slurry to form a coated electrode substrate; and
a multi-pass dryer configured to dry the coated electrode substrate,
wherein a web path length of the coated electrode substrate in the dryer is greater than a footprint length of the dryer.

2. The system of claim 1, further comprising a second coater configured to coat a second side of the electrode substrate opposite the first coated side of the electrode substrate with the electrode slurry to form a dual-side coated electrode substrate.

3. The system of claim 2, wherein the multi-pass dryer is configured to dry the dual-side coated electrode substrate and a web path of the dual-side coated electrode substrate in the dryer changes direction multiple times before exiting the dryer.

4. The system of claim 1, the web path of the coated electrode substrate within the dryer changes direction multiple times before exiting the dryer.

5. The system of claim 1, wherein a ratio of the web path length of the coated electrode substrate in the dryer to the footprint length of the dryer is 2:1 to 6:1.

6. The system of claim 1, wherein the electrode slurry comprises at least 50% solids by mass.

7. The system of claim 1, wherein the coater is a heated slot-die coater.

8. The system of claim 1, wherein the web path of the coated electrode substrate is vertically stacked within the dryer.

9. The system of claim 1, wherein the dryer comprises a plurality of rollers to move the coated electrode substrates along the web path.

10. The system of claim 1, wherein the dryer comprises at least one inductive heating source configured to heat the web path of the coated electrode substrate.

11. The system of claim 10, wherein the at least one inductive heating source comprises an induction coil wrapped around at least a portion of the web path of the coated electrode substrate.

12. The system of claim 1, wherein the dryer comprises at least one infrared heat source configured to heat the web path of the coated electrode substrate.

13. The system of claim 12, wherein the at least one infrared heat source comprises an infrared heating tube.

14. The system of claim 1, wherein the dryer comprises at least one convective heating nozzle configured to direct a flow of heated air toward the web path of the coated electrode substrate.

15. The system of claim 1, wherein the dryer comprises at least one floatation heating nozzle configured to float at least a portion of the web path of the coated electrode substrate with heated air.

16. A multi-pass dryer comprising:
an inlet configured to receive a coated electrode substrate;
a plurality of rollers configured to move the coated electrode substrate along a web path that changes direction multiple times within the dryer; and
an outlet configured to discharge the coated electrode substrate,
wherein the dryer is configured to dry the coated electrode substrate.

17. The dryer of claim 16, further comprising a second inlet configured to receive a dual-side coated electrode substrate; a second plurality of rollers configured to move the dual-side coated substrate along a web path that changes direction multiple times within the dryer; and a second outlet configured to discharge the dual-side coated electrode substrate, wherein the dryer is configured to dry the dual-side coated electrode substrate.

18. A method comprising:
coating a first side of an electrode substrate with an electrode slurry; and
drying the coated electrode substrate in a multi-pass dryer, wherein drying comprises moving the coated electrode substrate along a web path that changes direction multiple times within the dryer before exiting the dryer.

19. The method of claim 18, further comprising coating a second side of the electrode substrate opposite the first coated side of the electrode substrate with the electrode slurry to form a dual-side coated electrode substrate.

20. The method of claim 19, further comprising drying the dual-side coated electrode substrate comprising moving the dual-side coated electrode substrate along a web path that changes direction multiple times within the dryer before exiting the dryer.
